(19) United States
(12) Patent Application Publication
(10) Pub. No.: US 2010/0189337 A1
(43) Pub. Date: Jul. 29, 2010

(54) METHOD FOR ACQUIRING 3-DIMENSIONAL IMAGES OF CORONARY VESSELS, PARTICULARLY OF CORONARY VEINS

(75) Inventors: Uwe Jandt, Hamburg (DE); Dirk Schaefer, Hamburg (DE); Michael Grass, Buchholz In Der Norheide (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/668,043

(22) PCT Filed: Jul. 8, 2008
(86) PCT No.: PCT/IB08/52737

§ 371 Date: Jan. 7, 2010

(30) Foreign Application Priority Data
Jul. 11, 2007 (EP) 07112284.0

(51) Int. Cl. G06K 9/00

(52) U.S. Cl. 382/132

(57) ABSTRACT

A method and an apparatus for acquiring 3-dimensional images of coronary vessels (11), particularly of coronary veins, is proposed. 2-dimensional X-ray images (13) are acquired within a same phase of a cardiac motion. Then, a 3-dimensional centerline model (15) is generated based on these 2-dimensional images. From 2-dimensional projections of the centerline model into respective projection planes, the local diameters (w) of the vessels in the projection plane can be derived. Having the diameters, a 3-dimensional hull model of the vessel system can be generated and, optionally, 4-dimensional information about the vessel movement can be derived.

### FIELD OF THE INVENTION

The present invention relates to a method for acquiring 3-dimensional images of coronary vessels, particularly for acquiring 3-dimensional images of coronary veins moving in cyclic motion. Furthermore, the present invention relates to an apparatus adapted to performing such method, a computer program adapted to perform such method when executed on a computer and a computer readable medium comprising such program.

### TECHNICAL BACKGROUND

For medical purposes it may be important to precisely know the position, size, shape and/or movement of coronary vessels. For example, for a surgical treatment such as implanting a stent into coronary vessels, a surgeon must know the geometry of the vessel system to be treated, the position where the stent is to be placed and preferably the movement of the vessel system during the operation procedure. It may therefore be advantageous to provide a 3-dimensional image of the vessel system to be treated such that the surgeon may analyse the operation site prior to or during the actual operation. Furthermore, information about the time-dependent movement direction and/or movement velocity of vessel segments, also referred to as 4-dimensional model data, acquired before or during the actual operation may help to prevent difficulties from occurring during the actual operation procedure. Accordingly, the operation can be better planed, invasions can be held minimal and post-operational discomfort can be held minimal.

Rotational angiography has proven to be a very accurate and effective diagnostic tool in the treatment of static vessels with malformations such as e.g. cerebral vessels. In this approach, after injecting a contrast medium into the vessels, a C-arm having an X-ray source at its one end and a 2-dimensional X-ray detector at its opposing end rotates rapidly around the site to be imaged such as a patient's head while several 2-dimensional X-ray projections are acquired. From the multiplicity of 2-dimensional X-ray images acquired under various projection angles, a 3-dimensional reconstruction or model of the vessel system can be derived. Due to the high reproducibility of the rotational acquisitions, the fast rotation speed of the C-arm system and the relatively static nature of cerebral vessels, the projections can be used for volumetric reconstruction providing sufficiently high detail and accuracy.

However, when imaging moving objects like a beating heart, there may be a problem that a 3-dimensional reconstruction or model can only be calculated based on projections which have been acquired in a same phase of the heart's motion cycle where the heart and its coronary vessels are substantially at the same position. For acquiring corresponding projections for different viewing angles, the acquisition may have to be gated based e.g. on simultaneously recorded electrocardiogram (ECG) signals. Accordingly, although more than one hundred 2-dimensional images are acquired while rotating the C-arm e.g. 180° around the imaged site, only a few images are acquired at a same motion phase and can therefore be used for 3-dimensional reconstruction. As a result, the reconstructed 3-dimensional model may only yield a rough representation of the coronary vessels.

Furthermore, it may be necessary to image the coronary vessels during the surgical treatment. In such case, operation tools may restrict the available space around the patient such that the C-arm cannot be completely rotated around the operation site. Especially when coronary veins are to be treated surgically and therefore are to be imaged, due to the position of such veins, operation tools might have to be placed close to the side of the patient and might substantially restrict the available space for the C-arm. Accordingly, 2-dimensional projections can only be acquired in a range of less than 180°, e.g. only 110°. Accordingly, less 2-dimensional projections (e.g. less than 10 or usually even less than 6 projections) and therefore less image information of the coronary vessels is available for 3-dimensional reconstruction which may yield an insufficient 3-dimensional reconstruction quality derived therefrom.

Accordingly, there may be a need for an improved method for acquiring 3-dimensional images of coronary vessels such as particularly coronary veins with a high image quality. Furthermore, there may be a need for an apparatus adapted for performing such method, a computer program adapted for performing such method when executed on a computer and a computer readable medium comprising such program.

### SUMMARY OF THE INVENTION

These needs may be met by the subject-matter according to the independent claims. Advantageous embodiments of the present invention are described in the dependent claims.

According to a first aspect of the present invention, a method for acquiring 3-dimensional images of coronary vessels, the coronary vessels moving in a cyclic motion, is proposed, the method comprising at least the following steps preferably in the following order: (1) acquiring a plurality of 2-dimensional X-ray images of an acquisition region comprising the coronary vessels, wherein at least three 2-dimensional X-ray images are acquired in a substantially same phase of the cyclic motion under different projection angles; (2) generating at least one 3-dimensional centerline model of the vessels from the at least three 2-dimensional X-ray images acquired in a substantially same phase of the cyclic motion under different projection angles; (3) generating 2-dimensional fits of the at least one 3-dimensional centerline model onto the corresponding 2-dimensional X-ray images acquired in the substantially same phase of the cyclic motion; (4) deriving local vessel diameters from the 2-dimensional fits with respect to the different projection angles; (5) generating a 3-dimensional hull model representing a 3-dimensional image of the coronary vessels based on the derived local vessel diameters.

In other words, the first aspect of the present invention may be seen as based on the idea to derive a 3-dimensional hull model of a coronary vessel system such as a coronary vein system, the hull model having a good quality based on a small number of 2-dimensional X-ray images each acquired under different projection angles at a substantially same motion phase of the heart. For this purpose, after acquiring a multiplicity of 2-dimensional X-ray projections under different projection angles, a 3-dimensional centerline model representing the centerlines for each vessel of the vessel system is calculated from a number of X-ray projections acquired in substantially same phases of the heart motion cycle but under different projection angles. Then local diameters of the vessels are derived from fits of the 3-dimensional centerline model to the original 2-dimensional X-ray projection. This may be done for the plurality of 2-dimensional projections acquired at the substantially same motion phase but under different projection angles. From the thus derived diameters of the vessels in different projection planes, a 3-dimensional hull model of the vessel system can be derived with good quality. The 3-dimensional hull model provides a good representation of a 3-dimensional image of the coronary vessel system in the state of the substantially same phase of the heart motion from which the 3-dimensional centerline model has been derived.

In the following, possible features and advantages of the method according to the first aspect will be explained in detail.

As an aim of the method according to the first aspect of the present invention may be defined to provide a 3-dimensional image of coronary vessels, particularly of coronary veins, which are moving in a cyclic motion. The derived 3-dimensional hull model provided by the inventive method can e.g. be displayed on a screen. A surgeon can then analyse the coronary vessels prior or during a surgical operation. The 3-dimensional hull model can be observed from different viewing angle in order e.g. to search for anomalies in the vessel system.

First, a plurality of 2-dimensional X-ray images of an acquisition region comprising the coronary vessels to be imaged is acquired under different projection angles. For this purpose e.g. a C-arm system having an X-ray source and an opposing 2-dimensional X-ray detector can be rotated around a patient's corpus. The rotating movement can be performed over a range of e.g. 110° to up to 180°, depending e.g. on the space available for the C-arm movement during a surgical operation. During the rotating movement a multiplicity of 2-dimensional X-ray images can be obtained under different angles of projection. E.g. between 120 and 220 images can be obtained over the whole range of rotation. The rotating procedure takes a few seconds such that the patient's heart is beating several times during the rotation. Accordingly, during the repeating cyclic motion of the heart, several of the X-ray images are acquired at substantially the same phase of the heart cycle in subsequent heart cycles. In these substantially same phases, the heart is substantially in the same position in the patient's body and has substantially the same volume such that the coronary vessels are substantially in the same position. Accordingly, there are at least two X-ray images which are acquired in a substantially same phase of the cyclic motion but under different projection angles.

Herein, “in a substantially same phase” may be interpreted such that the difference between the current positions of the coronary vessels between two image acquisitions in the substantially same phase but in subsequent motion cycles is smaller than the diameter of the vessels to be imaged, preferably smaller than 20% of this diameter.

Prior to the acquisition of the X-ray images, contrast agent is preferably introduced into the coronary vessels to be observed. The contrast agent may be an X-ray absorbing fluid which can be introduced e.g. using a catheter inserted into one of the coronary vessels. A balloon may be deployed within a vessel in order to temporarily suppress the blood flow and hence to prevent the contrast agent from being washed out too quickly.

In order to improve the correspondence of the X-ray images acquired for the substantially same motion phases, the acquisition of the X-ray images may be gated based on an electrocardiogram (ECG) signal. For this purpose, while acquiring the plurality of X-ray images, an electrocardiogram is measured and the X-ray image acquisition may be triggered by certain characteristic signals of the ECG. For example, the R-peak may trigger or synchronize the X-ray image acquisition.

Subsequently, preferably at least some of the acquired 2-dimensional X-ray images are filtered using so-called vessel enhancement filters. A vessel enhancement filter may be an image processing tool which is adapted to search for geometrical structures, e.g. in an X-ray image, which can be regarded as tubular. Therein, the search for vessels can be restricted to vessel having a diameter larger than a certain minimum value. One possible vessel enhancement filtering method is described in A. F. Frangi et al. “Multiscale vessel enhancement filtering”, Medical Image Computing & Computer Assisted Interventions, MICCAI98, vol. 1496 of lecture Notes in Computer Science, pp. 130-7, 1998, the content of which is incorporated herein by reference.

In order to further improve the quality of the acquired X-ray images for subsequent further processing, the X-ray images can be subjected e.g. to 2-by-2 downsampling and/or high-pass filtering prior to the vessel enhancement procedure in order to improve the filter quality. The high-pass filtering may be performed in image space or in Fourier space.

Subsequently, the at least two 2-dimensional X-ray images acquired in a substantially same motion phase but under different projection angles can be used to generate a 3-dimensional centerline model of the vessels. The more 2-dimensional X-ray images for a substantially same motion phase can be provided for this purpose, the more precise the resulting centerline model can be.

Furthermore, it can be preferred that centerline models are generated for all or most of the various phases of the cyclic motion wherein a plurality of X-ray images is provided for each of such phases. In such case, one cardiac motion phase with all significant vessels being extracted at optimal quality may be selected, e.g. manually by the surgeon or by an automatic image evaluation process, for further processing. E.g. the end-diastolic motion phase at the end of the relaxation phase of the heart may be selected as there is minimal cardiac motion which may enhance the image quality of the acquired X-ray images and therefore result in a more precise centerline model.

One possible fully automated 3D centerline modeling algorithm for coronary arteries has been developed by inventors of the present inventions and is presented in Uwe Jandt, Dirk Schäfer, Volker Rasche, Michael Grass, “Automatic generation of 3D coronary artery centerlines using rotational X-ray angiography”, Proc. of SPIE Vol. 6510 65104Y, 2007, the content of which is incorporated herein by reference. The presented algorithm uses a subset of standard rotational X-ray angiography projections that correspond to a single cardiac phase. The projection selection may be based on a simultaneously recorded ECG. The algorithm utilizes a region growing approach which selects voxels in 3D space which most probably belong to the vascular structure. The local growing speed is controlled by a 3D response computation algorithm. This algorithm calculates a measure for the probability of a point in 3D to belong to a vessel or not. Centerlines of all detected vessels are extracted from the 3D representation built during the region growing and linked in a hierarchical manner. The centerlines representing the most significant vessels are selected by a geometry-based weighting criterion. According to the theoretically achievable accuracy of the algorithm, it is capable of extracting coronary centerlines with an accuracy that is mainly limited by projection and volume quantization (e.g. 0.25 mm). The algorithm needs at least three projections for modeling while, according to a phantom study using simulated projections of a virtual heart, five projections are sufficient to achieve the best possible accuracy. It has been shown that the algorithm is reasonably insensitive to residual motion, which means that it is able to cope with inconsistencies within the projection data set caused by finite gating accuracy, respiration or irregular heart beats.

After generating the at least one 3-dimensional centerline model, the obtained centerlines are fitted onto the corresponding 2-dimensional X-ray images. In other words, the 3-dimensional centerline is respectively projected into each of the 2-dimensional planes corresponding to the planes, on which the 3-dimensional centerline models have been originally acquired. This 2-dimensional centerline projection is compared with the corresponding original 2-dimensional X-ray image or, optionally, the 2-dimensional X-ray image after vessel enhancement filtering and/or downsampling and/or high-pass filtering and a best fit can be achieved. In this way, an optimal 2-dimensional centerline fit can be achieved for each of the 2-dimensional X-ray images of the set of X-ray images acquired for the same motion phase. The centerline fit may be performed in three dimensions for each projection independently, parallel to the detector plane of the considered projection and perpendicular to the local centerline direction. The center of each vessel may be defined as the maximum of the vessel enhanced projection within a small search region near the currently considered centerline point. Thereby, e.g. residual motion artifacts such as resulting from respiratory motion of the patient or from inaccurate gating can be compensated.

Having the projected and fitted 2-dimensional centerlines in the respective 2-dimensional projections, local diameters preferably of each point of all vessels can be derived in each projection plane. This means, for each point on a 2D centerline, the lateral distance to the border of the vessel can be determined. Thus, a data set including local vessel diameters can be derived for each projection plane for which originally an X-ray image has been acquired.

Having now a data set including a multiplicity of diameters in different projection planes for substantially each point of the centerline model, a 3-dimensional convex polygonal hull model of the vessel system can be generated. Optionally, the hull model may be even improved by cross-sectional and/or longitudinal regularization which means that artifacts in the hull model leading to a discontinuity or an unsteadiness may be smoothed in cross-sectional and/or longitudinal direction along the hull model. The hull model provides a good 3-dimensional representation of the surface of the vessel system and can e.g. displayed on a screen from different viewing angles.

However, the hull model obtained so far only gives a 3D representation of the vessel system in the specific motion phase which has previously been selected for deriving the 3-dimensional centerline model used for determining the local vessel diameters. In order to obtain hull models also in the other motion phases, a 2-dimensional projection of the 3-dimensional hull acquired for the substantially same phase of the cyclic motion can be fitted to 2-dimensional X-ray images of other phases of the cyclic motion of the heart. In other words, the extracted vessel surface mesh of the obtained hull model can be adapted to the contours of each X-ray projection of all distinguishable cardiac phases. The adaptation may be performed along to the local surface normal vectors.

In order to prevent artifacts or to improve the quality of the derived hull models in the other motion phases, competing edges on the projections may be weighted and evaluated under consideration of an internal energy term. In other words, from the original first hull model which may have been acquired with high quality as it is derived from an advantageous set of X-ray projection acquired e.g. at a low-motion phase of the heart at the end-diastolic phase, the hull models for the other motion phases can be derived taking into account that the first hull model can be “moved” during the motion of the heart in order to best match the X-ray images of other motion phases but that the first hull model has a certain “stiffness” such that it does not heavily bend or even fold during the motion.

In this way 3-dimensional hull models of the vessel system can be obtained for all phases of the heart motion.

Furthermore, in order to obtain a time-dependent 4-dimensional representation of the vessel motion, local shifting data can be determined indicating a time-dependent shift in the location of a vessel segment based on a difference between the 3-dimensional hull (or a 2-dimensional projection thereof) acquired for the substantially same phase of the cyclic motion at a first point in time and the 3-dimensional hull (or a 2-dimensional projection thereof) fitted to a 2-dimensional X-ray image of another phase of the cyclic motion at a second point in time. In other words, when deriving a 3-dimensional hull for a further motion phase, it can at the same time be determined, in which direction, to which amount and/or in which velocity the hull must be moved from the original state of the first motion phase to the state of the further motion phase in order to get a best fit with the actual X-ray images.

According to another aspect of the present invention, an apparatus for acquiring 3-dimensional images of cyclicly moving coronary vessels is proposed, the apparatus being adapted to perform the above described method.

The apparatus may include a C-arm system comprising an X-ray source for emitting X-rays and an X-ray detector for acquiring 2-dimensional X-ray images; optionally, a contrast medium injector for introducing a contrast medium into vessels such as veins of a patient; a control unit for controlling at least one of the X-ray source, the X-ray detector and the optional contrast medium injector; and a computing unit for computing 3-dimensional images of coronary vessels based on the acquired 2-dimensional X-ray images provided by the X-ray detector.

According to further aspects of the invention, a computer program element adapted to perform the above method when executed on a computer and a computer readable medium with such computer program element are proposed.

It has to be noted that embodiments of the invention are described with reference to different subject matters. In particular, some embodiments are described with reference to method type claims whereas other embodiments are described with reference to apparatus type claims. However, a person skilled in the art will gather from the above and the following description that, unless other notified, in addition to any combination of features belonging to one type of subject matter also any combination between features relating to different subject matters is considered to be disclosed with this application.

The aspects defined above and further aspects, features and advantages of the present invention can also be derived from the examples of embodiments to be described hereinafter and are explained with reference to examples of embodiments. The invention will be described in more detail hereinafter with reference to examples of embodiments but to which the invention is not limited.

### BRIEF DESCRIPTION OF THE DRAWINGS

FIG. 1 shows a flow diagram schematically representing a method for acquiring a 3-dimensional image of a coronary vein according to an embodiment of the present invention.

FIG. 2 shows a schematic representation of an apparatus for acquiring 3-dimensional images of a coronary vein according to an embodiment of the present invention.

### DETAILED DESCRIPTION OF PREFERRED EMBODIMENTS

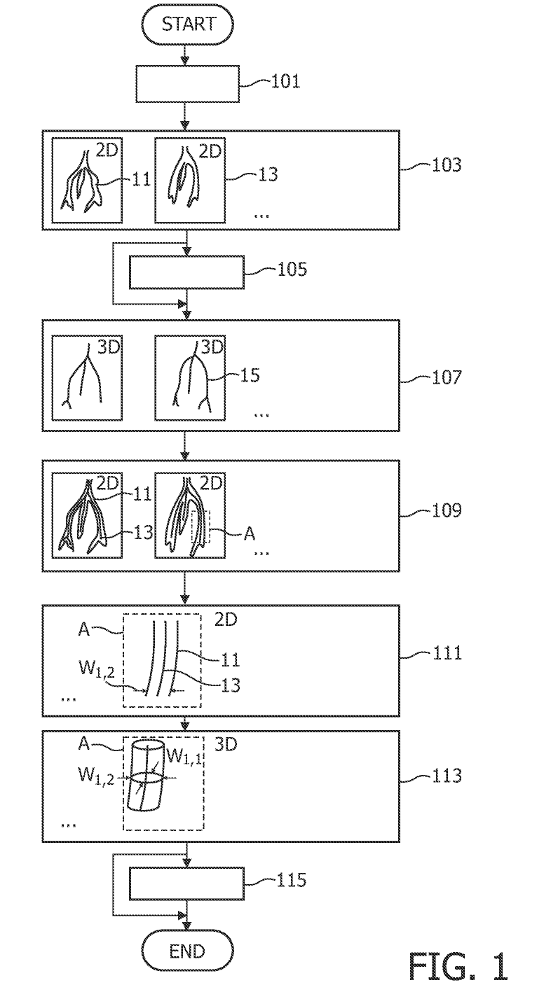

FIG. 1 can be used to explain the basic steps of a method for acquiring a 3-dimensional image of a coronary vein according to an embodiment of the present invention.

After locating a patient in a suitable apparatus such as a C-arm X-ray apparatus, contrast medium is injected into a coronary vein to be imaged using a catheter (step 101).

Then, a plurality of 2-dimensional X-ray images of an observation region including the veins 11 is acquired under different projection angles while rotating the C-arm around the patient's corpus (step 103) (only two images 13 shown exemplary).

Optionally, the acquired 2D images may be downsampled and/or filtered using a high-pass filter and/or a vessel enhancement filter (step 105) thereby improving the image quality with respect to the veins to be imaged.

From a specific number of 2D images acquired for a same motion phase such as the end-diastolic phase where there is minimum cardiac motion, a 3D centerline model 15 of the vein system is derived (step 107).

This 3D centerline model is then projected 2-dimensionally and fitted to the respective 2D images of the same motion phase but of different projection angles (step 109).

From the 2-dimensional fits, local diameters w_{i, j} of the veins are derived (step 111). The figure illustrating step 111 is an enlarged view of the region A indicated with respect to step 109.

Using the derived local diameters in different projection planes a 3D hull model is generated (step 113). Again, the figure schematically shows the partial region indicated with respect to step 109.

Optionally, the derived 3D hull model can then be adapted and fitted to X-ray images of other cardiac motion phases, thereby obtaining 4-dimensional information of the coronary vein movement (step 115).

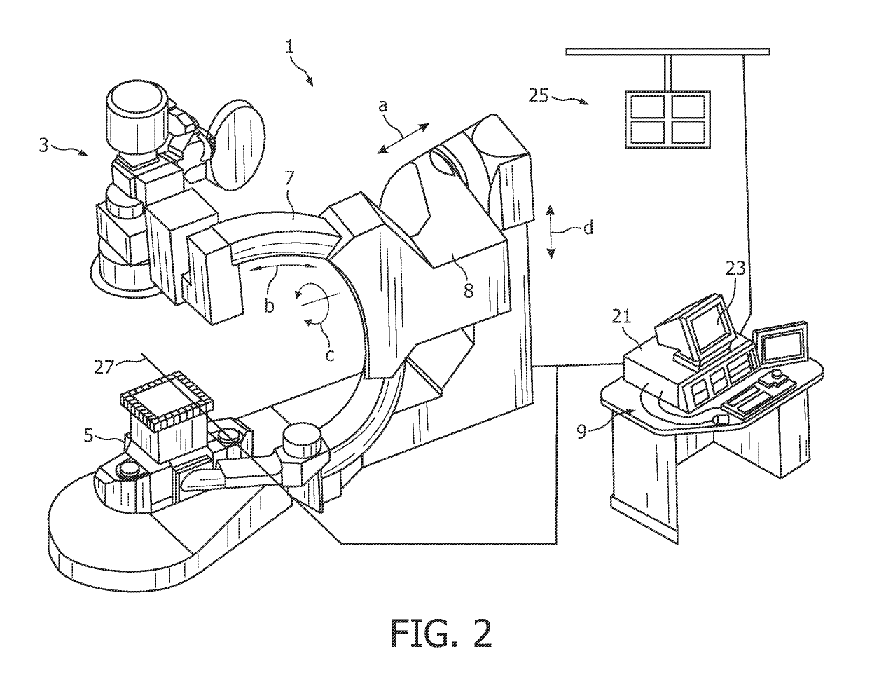

In FIG. 2 an apparatus for acquiring 3-dimensional images of coronary vessels according to an embodiment of the present invention is schematically shown. A C-arm system 1 comprises an X-ray source 3 and an X-ray detector 5. The C-arm 7 can be moved in the different directions a, b, c, d. For acquiring the different 2-dimensional X-ray projection images according to the above described method, the C-arm is preferably moved in the direction c along the holder 8. The acquisition of the X-ray projection may be gated based on an ECG signal which may be detected using electrodes 27 which can be attached to the patient and which may be connected to the control system 9.

A control unit 9 is connected to the C-arm system 1. The control unit 9 is adapted to control the X-ray source 3 and the X-ray detector 5 and the movement of the C-arm 7. The control system 9 includes a computing unit 21 which is adapted to perform the method according to the invention. Therefore, the computing unit can receive 2-dimensional image data from the detector 5, compute same and output the derived 3-dimensional hull model e.g. on a screen 23 or on a video system 25.

In a non-limiting attempt to recapitulate the above-described embodiments of the present invention one could state: A method and an apparatus for acquiring 3-dimensional images of coronary vessels (21), particularly of coronary veins, is proposed. 2-dimensional X-ray images (23) are acquired within a same phase of a cardiac motion. Then, a 3-dimensional centerline model (25) is generated based on these 2-dimensional images. From 2-dimensional projections of the centerline model into respective projection planes, the local diameters (w) of the vessels in the projection plane can be derived. Having the diameters, a 3-dimensional hull model of the vessel system can be generated and, optionally, 4-dimensional information about the vessel movement can be derived.

It should be noted that the term “comprising” does not exclude other elements or steps and the “a” or “an” does not exclude a plurality. Also elements described in association with different embodiments may be combined. It should also be noted that reference signs in the claims should not be construed as limiting the scope of the claims.

1. A method for acquiring 3-dimensional images of coronary vessels, the coronary vessels (11) moving in a cyclic motion, the method comprising:
acquiring a plurality of 2-dimensional X-ray images (13) of an acquisition region comprising the coronary vessels, wherein at least three 2-dimensional X-ray images are acquired in a substantially same phase of the cyclic motion under different projection angles;
generating at least one 3-dimensional centerline model (15) of the vessels from the at least three 2-dimensional X-ray images acquired in the substantially same phase of the cyclic motion under different projection angles;
generating 2-dimensional fits of the at least one 3-dimensional centerline model onto the corresponding 2-dimensional X-ray images acquired in the substantially same phase of the cyclic motion;
deriving local vessel diameters (w) from the 2-dimensional fits with respect to the different projection angles;
generating a 3-dimensional hull model of the vessels based on the derived local vessel diameters.

2. The method according to claim 1, further comprising
fitting a 2-dimensional projection of the 3-dimensional hull model acquired for the substantially same phase of the cyclic motion to 2-dimensional X-ray images of other phases of the cyclic motion.

3. The method according to claim 2, further comprising
determining local shifting data indicating a time-dependent shift in the location of a vessel segment based on a difference between the 2-dimensional projection of the 3-dimensional hull acquired for the substantially same phase of the cyclic motion at a first point in time and the 2-dimensional projection of the 3-dimensional hull fitted to a 2-dimensional X-ray image of another phase of the cyclic motion at a second point in time.

4. The method according to claim 1, further comprising
filtering the acquired 2-dimensional X-ray images prior to generating the at least one 3-dimensional centerline model using a vessel enhancement filter;

5. The method according to claim 1, further comprising
at least one of downsampling and high-pass-filtering of the acquired 2-dimensional X-ray images prior to generating the at least one 3-dimensional centerline model.

6. The method according to claim 1, wherein the 2-dimensional X-ray images are acquired under projection angles of between 110° and 180°.

7. The method according to claim 1, wherein
the 2-dimensional X-ray images are acquired using a C-arm system.

8. The method according to claim 1, further comprising at least one of cross-sectional and longitudinal regularization of the generated 3-dimensional hull.

9. The method according to claim 1,
wherein the acquisition of the 2-dimensional X-ray images is gated based on an electrocardiogram signal

10. The method according to claim 1,
wherein the coronary vessels are coronary veins.

11. The method according to claim 10, further comprising
injecting contrast agent into the coronary veins before acquiring the 2-dimensional X-ray images.

12. Apparatus for acquiring 3-dimensional images of coronary vessels, the coronary vessels moving in a cyclic motion, the apparatus being adapted to perform the method according to claim 1.

13. Apparatus according to claim 12, including
a C-arm system (1) comprising an X-ray source (3) for emitting X-rays and an X-ray detector (5) for acquiring 2-dimensional X-ray images;
a control unit (9) for controlling at least one of the X-ray source and the X-ray detector;
a computing unit (11) for computing 3-dimensional images of coronary vessels based on the acquired 2-dimensional X-ray images provided by the X-ray detector.

14. Computer program element adapted to perform the method according claim 1 when executed on a computer.

15. Computer readable medium with a computer program element according to claim 14.
